(19) United States
(12) Patent Application Publication
(10) Pub. No.: US 2008/0249816 A1
(43) Pub. Date: Oct. 9, 2008

(54) System and Method for Monitoring Workflow in a Project Management System

(76) Inventors: Luke Khalilian, New York, NY (US); Christopher J. Long, Chatham, NJ (US); Shant Sarkuni, Jersey City, NJ (US)

Correspondence Address: BAKER BOTTS L.L.P., 2001 ROSS AVENUE, SUITE 600, DALLAS, TX, 75201-2980, US

(21) Appl. No.: 11/762,529

(22) Filed: Jun. 13, 2007

Related U.S. Application Data
(60) Provisional application No. 60/910,320, filed on Apr. 5, 2007.

(51) Int. Cl. G06F 17/00

(52) U.S. Cl. 705/7

(57) ABSTRACT

A system comprises a memory operable to store one or more workpapers. The system further comprises a processor communicatively coupled to the memory and operable to determine a completion percentage associated with a particular workstream. The particular workstream may be associated with a plurality of workpapers. A first portion of the plurality of workpapers may be in a first stage of completion, and a second portion of the plurality of workpapers may be in a second stage of completion. Determining the completion percentage may comprise determining a first percentage based at least in part on the first portion and a first weight, determining a second percentage based at least in part on the second portion and a second weight, and adding the first percentage and the second percentage. The processor is further operable to store the determined completion percentage in a memory.

### RELATED APPLICATION

This patent application claims priority to patent application Ser. No. 60/910,320, filed Apr. 5, 2007, entitled System and Method for Monitoring Workflow in a Project Management System.

### TECHNICAL FIELD OF THE INVENTION

The present invention relates generally to workflow management and more specifically to a system and method for monitoring workflow in a project management system.

### BACKGROUND OF THE INVENTION

Traditional workflow systems allow multiple users to participate in one or more tasks associated with a project. When multiple tasks are assigned to multiple different users, however, traditional workflow systems are unable to efficiently track and report the current status of the overall project.

### SUMMARY OF THE INVENTION

In accordance with the present invention, the disadvantages and problems associated with prior trading systems have been substantially reduced or eliminated.

In some embodiments, a system comprises a memory operable to store one or more workpapers. The system further comprises a processor communicatively coupled to the memory and operable to determine a completion percentage associated with a particular workstream. The particular workstream may be associated with a plurality of workpapers. A first portion of the plurality of workpapers may be in a first stage of completion, and a second portion of the plurality of workpapers may be in a second stage of completion. Determining the completion percentage may comprise determining a first percentage based at least in part on the first portion and a first weight, determining a second percentage based at least in part on the second portion and a second weight, and adding the first percentage and the second percentage. The processor is further operable to store the determined completion percentage in a memory.

In other embodiments, a method comprises determining a completion percentage associated with a particular workstream. The particular workstream may be associated with a plurality of workpapers. A first portion of the plurality of workpapers may be in a first stage of completion, and a second portion of the plurality of workpapers may be in a second stage of completion. Determining the completion percentage may comprise determining a first percentage based at least in part on the first portion and a first weight, determining a second percentage based at least in part on the second portion and a second weight, and adding the first percentage and the second percentage. The method concludes by storing the determined completion percentage in a memory.

The invention has several important technical advantages. Various embodiments of the invention may have none, some, or all of these advantages. One advantage is that a user interface may display a project map that represents an efficient dashboard for monitoring the status of workstreams, reviewing due dates, and navigating to workpapers. Another advantage is that, for any given workstream, the user interface may display a completion percentage that provides a detailed indication of the current status of the given workstream. Yet another advantage is that a workflow system is operable to dynamically manage file permissions based at least in part on workstream events. Other advantages of the present invention will be readily apparent to one skilled in the art from the description and the appended claims.

### BRIEF DESCRIPTION OF THE DRAWINGS

For a more complete understanding of the present invention and its advantages, reference is now made to the following description taken in conjunction with the accompanying drawings, in which:

FIG. 1 illustrates a workflow system, according to certain embodiments;

FIG. 2 illustrates an example workstream profile, according to certain embodiments;

FIG. 3 illustrates an example user interface for displaying a project map and a completion percentage, according to certain embodiments;

FIG. 4 illustrates a flowchart for updating a completion percentage associated with a particular workstream, according to certain embodiments;

FIG. 5 illustrates an example user interface for monitoring file permissions associated with workpapers, according to certain embodiments; and

FIG. 6 illustrates an example lead sheet of a workpaper, according to certain embodiments.

### DETAILED DESCRIPTION OF THE INVENTION

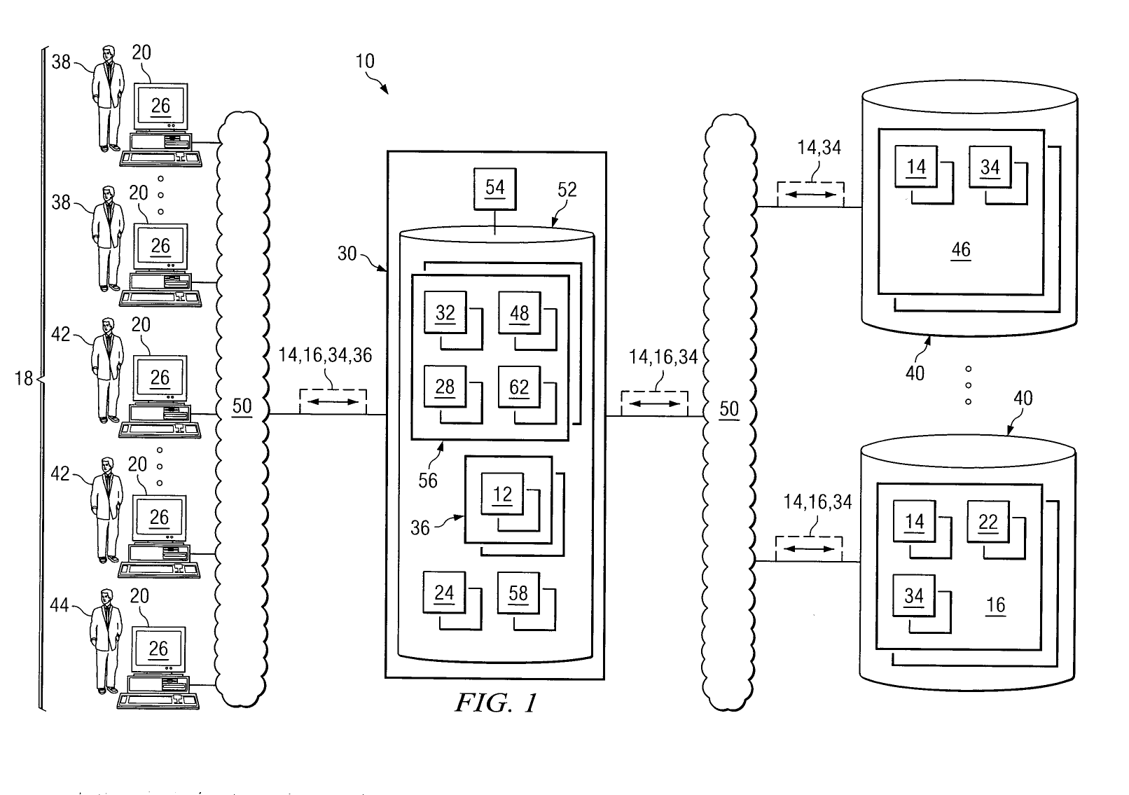

FIG. 1 illustrates a workflow system 10, according to certain embodiments. Workflow system 10 may comprise clients 20, manager server 30, and storage modules 40 communicatively coupled by a network 50. Workflow system 10 is generally operable to monitor workstreams 12 associated with one or more projects, to manage the retrieval and processing of source data 14 associated with workstreams 12, and to generate and format workpapers 16 for a plurality of users 18 associated with workflow system 10. Workflow system 10 may manage file permissions 22 associated with workpapers 16 and may generate and manage workpaper templates 24.

In some embodiments, workflow system 10 generates a graphical user interface (GUI) 26 that provides a dashboard view of multiple workstreams 12 associated with a particular project. GUI 26 allows user 18 to select a particular workstream 12 to navigate to and launch workpapers 16 associated with the particular workstream 12. Upon receiving a selection of a particular workstream 12, workflow system 10 may determine a completion percentage 28 associated with the particular workstream 12. Completion percentage 28 may be a weighted numerical indicator of the estimated time, cost, and/or resources that are needed to complete the selected workstream 12. In some embodiments, completion percentage 28 for a particular workstream 12 may be based on the current stage 32 of completion of each workpaper 16 associated with the particular workstation. Thus, in some embodiments, workflow system 10 may efficiently provide a real-time or substantially real-time indicator of the status of any given workstream 12 even though multiple different users 18 may be concurrently working on different aspects of the given workstream 12.

As explained above, workflow system 10 may comprise one or more clients 20. Client 20 represents any suitable local or remote end-user device that may be used by users 18 to access one or more elements of workflow system 10, such as manager server 30. In some embodiments, a particular user 18 may use client 20 to monitor the status of one or more workstreams 12 and/or to prepare workpapers 16 assigned to the particular user 18. According to certain embodiments, a particular user 18 may use client 20 to review workpapers 16 that were prepared by other users 18. A particular user 18 may use client 20 to view source data 14, calculate reporting values 34, navigate to workpapers 16 stored in workflow system 10, and/or launch applications associated with workpapers 16.

A particular client 20 may comprise a computer, workstation, Internet browser, electronic notebook, Personal Digital Assistant (PDA), pager, cell phone, or any other suitable device (wireless, wireline, or otherwise), component, or element capable of receiving, processing, storing, and/or communicating information with other components of workflow system 10. Client 20 may also comprise any suitable user interface such as a display, microphone, keyboard, and/or any other appropriate terminal equipment according to particular configurations and arrangements. It will be understood that workflow system 10 may comprise any number and combination of clients 20.

In some embodiments, client 20 may comprise a graphical user interface (GUI) 26. GUI 26 is generally operable to tailor and filter data presented to user 18. GUI 26 may provide user 18 with an efficient and user-friendly presentation of a project map 36, source data 14, workpapers 16, task lists, completion percentages 28, and/or other suitable information. GUI 26 may comprise a plurality of displays having interactive fields, pull-down lists, and buttons operated by user 18. In one example, GUI 26 presents relevant information to user 18 and conceals the remaining information to reduce visual clutter. Then, upon receiving a request from user 18, GUI 26 expands the visual representation of information to display source data 14, directory information, and/or other suitable information. GUI 26 may include multiple levels of abstraction including groupings and boundaries. It should be understood that the term graphical user interface may be used in the singular or in the plural to describe one or more graphical user interfaces 26 and each of the displays of a particular graphical user interface 26.

Clients 20 may be used by users 18. The term “user” is meant to broadly apply to any individual or entity that prepares workpapers 16, reviews workpapers 16, views source data 14, configures templates 24, and/or otherwise participates in workflow system 10. According to certain embodiments, a particular user 18 may be a preparer 38, a reviewer 42, and/or an administrator 44.

The term “preparer” refers to any individual or entity that is responsible for drafting or preparing a particular workpaper 16. In some embodiments, preparer 38 launches the particular workpaper 16, updates the particular workpaper 16 with current source data 14, and/or calculates reporting values 34 based at least in part on source data 14 in the particular workpaper 16. According to certain embodiments, after completing the calculations of reporting values 34 for a particular workpaper 16, preparer 38 may submit the particular workpaper 16 for review.

The term “reviewer” refers to any individual or entity that is responsible for reviewing a particular workpaper 16 submitted by preparer 38. Reviewer 42 may check source data 14 and/or calculations in workpaper 16. In some embodiments, reviewer 42 may verify that the calculation of reporting values 34 in workpaper 16 comply with applicable guidelines. For example, reviewer 42 may verify that reporting values 34 in workpaper 16 comply with Generally Accepted Accounting Principles (GAAP), tax codes, applicable legal standards, and/or any suitable guidelines. In some embodiments, if reviewer 42 determines that workpaper 16 complies with the applicable guidelines, reviewer 42 may designate workpaper 16 as approved. If reviewer 42 determines that workpaper 16 does not comply with the applicable guidelines, reviewer 42 may reject workpaper 16. In certain embodiments, if reviewer 42 rejects workpaper 16, then workflow system 10 may route the rejected workpaper 16 back to the task list of preparer 38.

The term “administrator” refers to any individual or entity that supervises and/or manages the operation of workflow system 10. In certain embodiments, administrator 44 configures workpaper templates 24, commands workflow system 10 to create workpapers 16, monitors file permissions 22, and/or otherwise manages the operation of workflow system 10. As explained above, each preparer 38, reviewer 42, and administrator 44 in workflow system 10 may be associated with at least one client 20.

Workflow system 10 may comprise any suitable number and combination of users 18. As explained above, each workstream 12 may comprise a plurality of workpapers 16. In some embodiments, each workpaper 16 in workstream 12 may be assigned to a respective preparer 38 and reviewer 42. A particular user 18 that is designated as a preparer 38 for a particular workpaper 16 may be designated as a reviewer 42 for another workpaper 16. Similarly, a particular user 18 that is designated as a reviewer 42 for a particular workpaper 16 may be designated as a preparer 38 for another workpaper 16.

In some embodiments, clients 20 may be communicatively coupled to manager server 30 via network 50. Manager server 30 is operable to use templates 24 to generate workpapers 16. Manager server 30 is further operable to import source data 14 from database 46 into workpapers 16. In some embodiments, manager server 30 is operable to monitor the progress of each workpaper 16 in a particular workstream 12 and to calculate completion percentage 28 associated with the particular workstream 12. Manager server 30 may generate a project map 36 based at least in part on a plurality of workstreams 12. In some embodiments, manager server 30 may cause clients 20 to display the generated project map 36.

Project map 36 refers to a map, chart, diagram, and/or other suitable representation of the status of one or more workstreams 12. As explained above, a particular project may comprise a plurality of workstreams 12. For example, a project to prepare tax filings for a corporation may comprise a first workstream 12 to prepare state tax filings, a second workstream 12 to prepare federal tax filings, and a third workstream 12 to prepare international tax filings. Each workstream 12 may comprise a plurality of assignments. In some embodiments, each assignment is associated with a respective workpaper 16. For example, the first workstream 12—preparing state tax filings—may comprise a first assignment to determine meals and entertainment expenses, a second assignment to determine depreciation expenses, a third assignment to determine accounts payable, and so forth. Each assignment may be associated with a respective workpaper 16. For example, the first assignment—determining meals and entertainment expenses—may be associated with a particular workpaper 16 that is configured with formulas, algorithms, tables, and/or logic for calculating meals and entertainment expenses. In some embodiments, workpaper 16 may be formatted as an electronic spreadsheet, ledger, and/or other suitable document.

In some embodiments, project map 36 provides a dashboard-style view of the status of the respective workstreams 12 associated with a particular project. According to certain embodiments, user 18 may select a particular workstream 12 in project map 36 to drill down to a list of assignments associated with the selected workstream 12. User 18 may select a particular workstream 12 in project map 36 to view a completion percentage 28 associated with the selected workstream 12.

According to certain embodiments, completion percentage 28 indicates the percentage of a workstream 12 that has been or has yet to be completed. In some embodiments, manager server 30 is operable to monitor the status of each workpaper 16 in a particular workstream 12. For a particular workpaper 16, manager server 30 may determine the particular stage 32 of completion. For example, manager server 30 may determine whether the particular workpaper 16 is in progress, whether the particular workpaper 16 has been submitted for review, and/or whether the particular workpaper 16 has been approved or rejected by reviewer 42. Based at least in part on the determined stage 32 of each workpaper 16, manager server 30 may determine the completion percentage 28 of workstream 12.

In calculating completion percentage 28, manager server 30 may weigh different stages 32 of completion differently. Because the time or cost required to complete a workpaper 16 that is in a first stage 32 may be different than the time or cost to complete a workpaper 16 that is in a second stage 32, manager server 30 may weigh the first and second stage 32 differently. Thus, each stage 32 of completion may be associated with a respective weight 48. In some embodiments, weights 48 may be stored in manager server 30.

According to certain embodiments, manager server 30 may comprise any suitable combination of hardware and/or software implemented in one or more modules to provide the described functions and operations. In some embodiments, manager server 30 may comprise a general-purpose personal computer (PC), a Macintosh, a workstation, a Unix-based computer, a server computer, or any suitable processing device. In some embodiments, the functions and operations described above may be performed by a pool of multiple manager servers 30. A particular manager server 30 may comprise a memory 52 and a processor 54.

Memory 52 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information such as project map 36. Although FIG. 1 illustrates memory 52 as internal to manager server 30, it should be understood that memory 52 may be internal or external to manager server 30, depending on particular implementations. Also, memory 52 may be separate from or integral to other memory devices, such as storage modules 40, to achieve any suitable arrangement of memory devices for use in workflow system 10.

Memory 52 is generally operable to store project map 36, completion percentages 28, weights 48, workstream profiles 56, templates 24, and manager logic 58. Workstream profile 56 generally comprises information regarding workstream 12. In particular, workstream profile 56 for a particular workstream 12 may comprise a list of workpapers 16 associated with the particular workstream 12, the current stage 32 of completion of each workpaper 16, the identities of the particular preparers 38 and reviewers 42 assigned to workpapers 16, and/or other suitable information regarding workstream 12. In some embodiments, workstream profile 56 comprises the particular weights 48 associated with the respective stages 32 of the particular workstream 12. As workpapers 16 are prepared and approved, manager server 30 is operable to update workstream profile 56 to indicate the updated status of each workpaper 16. In some embodiments, memory 52 stores a particular workstream profile 56 for each workstream 12 associated with workflow system 10.

Memory 52 is further operable to store templates 24. As explained above, a particular workstream 12 may comprise a plurality of assignments. Each assignment may be associated with one or more workpapers 16. Manager server 30 may use templates 24 stored in memory 52 to format workpapers 16 according to standardized formats. Thus, regardless of which user 18 is assigned to prepare or review a given workpaper 16, each workpaper 16 associated with a particular type of assignment may be formatted uniformly. By using templates 24 to format workpapers 16, manager server 30 may protect the integrity of the information and calculations in workflow system 10.

Memory 52 is operable to store manager logic 58. Manager logic 58 generally comprises rules, algorithms, code, tables, and/or other suitable instructions for performing the described functions and operations.

Memory 52 is communicatively coupled to processor 54. Processor 54 is generally operable to execute manager logic 58 stored in memory 52 to perform the described functions and operations. Processor 54 may comprise any suitable combination of hardware and software implemented in one or more modules to provide the described functions and operations.

Manager server 30 may be communicatively coupled to one or more storage modules 40 via network 50. Storage module 40 is generally operable to store workpapers 16, workstream profiles 56, databases 46, and/or other information associated with workflow system 10. Storage module 40 may represent any memory device, direct access storage device (DASD), or database module and may take the form of volatile or non-volatile memory comprising, without limitation, magnetic media, optical media, random access memory (RAM), read-only memory (ROM), removable media, or any other suitable local or remote memory component. It will be understood that there may be any suitable number and combination of repositories communicatively coupled to manager server 30.

Storage modules 40 may comprise one or more databases 46. Database 46 is a matrix, table, compilation, and/or grouping of data. In database 46, data may be organized and/or linked in any suitable fashion. For example, in a hierarchical database 46, data may be linked in a tree-like logical structure. Database 46 may represent an IMS database, an online analytical processing database, an online transaction processing database, a flat-file database, a network database, a relational database, an object-oriented database, and/or any other suitable number and combination of databases. In some embodiments, the data in database 46 comprises source data 14 and reporting values 34.

In some embodiments, source data 14 represents raw and/or partially processed data associated with a particular project. For example, if a particular project is to prepare tax filings for a corporation, source data 14 may comprise records of individual receipts, invoice records, individual billing entries, records of asset values, and/or other suitable information. According to certain embodiments, workpapers 16 associated with the particular project may be configured to categorize, filter, and/or process source data 14 to generate finalized and/or formatted values that are suitable for listing in regulatory filings, prospectuses, audit reports, and/or other formal documents. These finalized and/or formatted values may be referred to as reporting values 34.

An example illustrates certain embodiments. A particular project is to prepare tax filings. In this example, database 46 may comprise source data 14 such as, for example, individual paycheck values. A particular workpaper 16 may be configured to process the individual paycheck values to generate a reporting value 34 such as, for example, an Adjusted Gross Income (AGI) value. The AGI value may represent a reporting value 34 that is suitable for listing in a tax form. According to certain embodiments, manager system is operable to import source data 14 from database 46 into workpapers 16, calculate reporting values 34 in workpapers 16, and copy the calculated reporting values 34 from workpapers 16 to database 46.

As explained above, clients 20, manager server 30, and storage modules 40 may be communicatively coupled via one or more networks 50. Network 50 may represent any number and combination of wireline and/or wireless networks suitable for data transmission. Network 50 may, for example, communicate internet protocol packets, frame relay frames, asynchronous transfer mode cells, and/or other suitable information between network addresses. Network 50 may include one or more intranets, local area networks, metropolitan area networks, wide area networks, cellular networks, all or a portion of the Internet, and/or any other communication system or systems at one or more locations.

It should be understood that the internal structure of workflow system 10 and the servers, processors, and memory devices associated therewith is malleable and can be readily changed, modified, rearranged, or reconfigured to achieve the intended operations of workflow system 10.

In operation, administrator 44 is operator to load into workflow system 10 a project that comprises a plurality of workstreams 12. To load the project, administrator 44 may use client 20 to define each workstream 12 associated with the project. For example, if the project is to prepare tax filings for a corporation, the administrator 44 may use client 20 to designate the preparation of state tax filings as a first workstream 12, the preparation of federal tax filings as a second workstream 12, the preparation of international tax filings as a third workstream 12, and so forth. In conjunction with defining a particular workstream 12, administrator 44 may identify the particular assignments in the particular workstream 12. For example, if the particular workstream 12 is the preparation of state tax filings, a first assignment may be the determination of meals and entertainment expenses, a second assignment may be the determination of depreciation expenses, and so forth.

According to certain embodiments, each assignment in workstream 12 may be assigned to a respective preparer 38 and reviewer 42. In some embodiments, each type of assignment may be associated with a respective workpaper template 24. For example, if the assignment is to determine depreciation expenses, the assignment may be associated with a workpaper template 24 for calculating depreciation expenses. In this example, the particular workpaper template 24 may be configured with formulas and data fields for calculating depreciation expenses. According to certain embodiments, once administrator 44 has identified the particular assignments in each workstream 12, manager server 30 may use workpaper templates 24 stored in memory 52 to generate at least one workpaper 16 for each assignment in workstream 12. Manager server 30 may store the generated workpapers 16 in storage module 40.

In conjunction with generating workpapers 16, manager server 30 may notify each preparer 38 regarding the particular workpapers 16 that have been assigned to that preparer 38. In particular, manager server 30 may cause client 20 associated with a particular preparer 38 to display a task list that includes the particular workpapers 16 that have been assigned to the particular preparer 38. To begin working on a particular workpaper 16, preparer 38 may use client 20 to select the particular workpaper 16 from the task list. Client 20 may transmit the selection of the particular workpaper 16 to manager server 30. In response to receiving the selection of the particular workpaper 16, manager server 30 may launch the application associated with the selected workpaper 16 and retrieve the selected workpaper 16 from storage module 40.

According to certain embodiments, a portion of the selected workpaper 16 may be configured with one or more queries for retrieving source data 14 from database 46. The one or more queries may be specified by workpaper template 24 associated with the selected workpaper 16. Thus, when manager server 30 generates a particular workpaper 16, the particular workpaper 16 may be automatically configured with one or more queries according to workpaper template 24. In some embodiments, workpaper 16 may represent a spreadsheet such as, for example, a Microsoft Excel spreadsheet, a WordPerfect Quattro Pro spreadsheet, a Papyrus spreadsheet, and/or any suitable spreadsheet. In other embodiments, workpaper 16 may represent a word processing document, an XML file, a text file, and/or any suitable file for use with any number and combination of suitable applications and/or operating systems.

In some embodiments, workpaper 16 may comprise a plurality of sheets. For example, a workpaper 16 that is formatted as an Excel spreadsheet may comprise multiple sheets. In some embodiments, a first sheet may be configured with one or more queries for retrieving source data 14 from database 46. This sheet may be referred to as a “data sheet.” Manager server 30 may be operable to retrieve source data 14 from database 46 based at least in part on queries in data sheet of workpaper 16. Manager server 30 may be operable to populate the data sheet with the retrieved source data 14. According to certain embodiments, a second sheet of workpaper 16 may be configured with formulas, tables, and/or algorithms for processing source data 14 from data sheet and for calculating reporting values 34. This second sheet may be referred to as a “calculation sheet.” In some embodiments, the reporting values 34 calculated by the formulas, tables, and/or algorithms in the calculation sheet may be displayed on a third sheet of workpaper 16. This third sheet may be referred to as a “lead sheet.”

Once reporting values 34 are calculated in workpaper 16, preparer 38 may save workpaper 16 and submit workpaper 16 for review. In some embodiments, preparer 38 may submit workpaper 16 for review by toggling an icon displayed in GUI 26. Once preparer 38 submits workpaper 16 for review, manager server 30 may notify reviewer 42 associated with workpaper 16. In some embodiments, manager server 30 may cause client 20 associated with reviewer 42 to display a task list that includes the particular workpaper 16. To begin reviewing the particular workpaper 16, reviewer 42 may select the particular workpaper 16 from the task list. In response, manager server 30 retrieve the selected workpaper 16 from storage module 40 and open the selected workpaper 16.

According to certain embodiments, reviewer 42 may view the information in workpaper 16 to determine whether workpaper 16 complies with applicable guidelines such as, for example, GAAP, tax rules, and/or other suitable guidelines. If reviewer 42 determines that workpaper 16 complies with the applicable guidelines, reviewer 42 may sign off or approve the particular workpaper 16. In some embodiments, reviewer 42 may approve or reject the particular workpaper 16 by toggling an icon displayed by client 20. Once reviewer 42 approves workpaper 16, manager server 30 may record in workstream profile 56 that the particular workpaper 16 has been approved. If, however, reviewer 42 determines that workpaper 16 does not comply with the applicable guidelines, then reviewer 42 may reject the particular workpaper 16. Once reviewer 42 rejects workpaper 16, manager server 30 may cause client 20 associated with preparer 38 to display a task list that includes the rejected workpaper 16. Preparer 38 may then open the rejected workpaper 16, make suitable corrections, and again submit the corrected workpaper 16 for review.

An example illustrates certain embodiments. In this example, Preparer A and Reviewer B have been assigned to determine depreciation expenses for Company X. Storage module 40 comprises a particular workpaper 16 associated with this assignment. In this example, manager server 30 generated the particular workpaper 16 based at least in part on a particular workpaper template 24, stored in memory 52, for determining depreciation expenses. Based at least in part on the particular workpaper template 24, the particular workpaper 16 comprises (1) queries for retrieving source data 14 associated with depreciation expenses of Company X and (2) formulas for processing source data 14 to determine reporting values 34 associated with depreciation expenses.

In this example, Preparer A uses project map 36 displayed by GUI 26 to navigate to and open the particular workpaper 16. In conjunction with opening the particular workpaper 16, manager server 30 executes the queries stored in workpaper 16 to retrieve source data 14 from database 46 in storage module 40. Manager server 30 populates a data sheet of workpaper 16 with the retrieved source data 14. In the present example, manager server 30 then executes the formulas in a calculation sheet of workpaper 16 to process source data 14 from the data sheet of workpaper 16. Based at least in part on the processing of source data 14, manager server 30 determines reporting values 34. In this example, manager server 30 stores the determined reporting values 34 in a lead sheet of workpaper 16.

In the present example, Preparer A is operable to review the retrieved source data 14, the calculations, and the determined reporting values 34. In some embodiments, Preparer A may evaluate whether the calculations and reporting values 34 comply with applicable guidelines such as, for example, regulatory guidelines and tax codes. In the present example, Preparer A then uses client 20 to submit workpaper 16 for review. In response, manager server 30 notifies Reviewer B that workpaper 16 has been submitted for review. Reviewer B may then use client 20 to open and review workpaper 16. In some embodiments, Reviewer B may approve or reject workpaper 16. If Reviewer B designates workpaper 16 as approved, then manager server 30 may copy reporting values 34 from the lead sheet of workpaper 16 into database 46 in storage module 40.

In some embodiments, manager server 30 is operable to store in a particular workstream profile 56 the respective status of each workpaper 16 associated with the particular workstream 12. For a particular workpaper 16, the recorded status may correspond to the stage 32 of completion of the particular workpaper 16. In some embodiments, manager server 30 may be configured such that a first stage 32 comprises workpapers 16 that have been started but not submitted for review (“In Progress”), a second stage 32 comprises workpapers 16 that have been submitted for review (“Under Review”), and a third stage 32 comprises workpapers 16 that have been approved (“Approved”). According to certain embodiments, a fourth stage 32 may comprise workpapers 16 on which the respective preparer 38 has not begun working (“Not Started”).

According to certain embodiments, manager server 30 may determine a completion percentage 28 for a particular workstream 12 based at least in part on information stored in workstream profile 56 associated with the particular workstream 12. Manager server 30 may determine, from workstream profile 56, the total number of workpapers 16 associated with the particular workstream 12. Manager server 30 may further determine, from workstream profile 56, the respective number of workpapers 16 in each stage 32 of completion.

In some embodiments, workstream profile 56 comprises a respective weight 48 for each stage 32 of completion. A particular weight 48 for a particular stage 32 of completion may correspond to the estimated time or cost required to complete a particular workpaper 16 that is currently in the particular stage 32 of completion. For example, if the estimated time to complete a particular workpaper 16 that is “In Progress” is ten hours, then weight 48 associated with the “In Progress” stage 32 may be 0.10 (e.g., the inverse value of ten.) As another example, if the estimated time to complete a particular workpaper 16 that is “Under Review” is two hours, then weight 48 associated with the “Under Review” stage 32 may be 0.50 (e.g., the inverse value of two). Thus, the particular weight 48 associated with a particular stage 32 of completion may be based at least in part on the estimated amount of time required to complete workpaper 16 in the particular stage 32. In other embodiments, the particular weight 48 associated with a particular stage 32 may be based at least in part on the estimated cost required to complete workpaper 16, the estimated system resources required to complete workpaper 16, and/or on any number and combination of suitable criteria.

Based at least in part on the respective number of workpapers 16 in each stage 32 of completion and on the respective weights 48 stored in workstream profile 56, manager server 30 may determine the current completion percentage 28 associated with the particular workstream 12. Manager server 30 may cause clients 20 to display the current completion percentage 28 associated with the particular workstream 12.

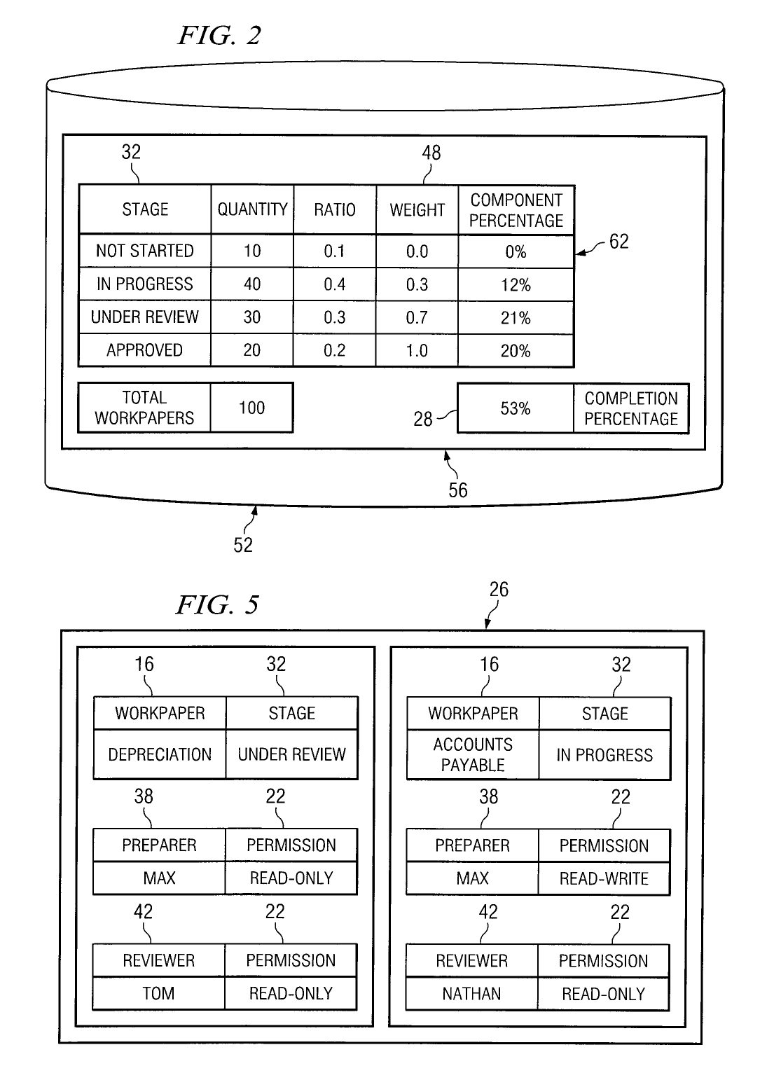

FIG. 2 illustrates an example workstream profile 56, according to certain embodiments. In the present example, a particular workstream 12 is to prepare the June 2006 state tax filings for a particular corporation. Memory 52 comprises a workstream profile 56 for the particular workstream 12. In this example, the particular workstream 12 comprises one hundred workpapers 16. A plurality of preparers 38 and reviewers 42 are assigned to complete various workpapers 16 associated with the particular workstream 12.

In this example, each workpaper 16 represents a respective Excel spreadsheet. Each spreadsheet comprises a data sheet into which manager server 30 loads source data 14 from database 46. Each spreadsheet further comprises formulas, configured according to one or more workpaper templates 24, that are used to determine reporting values 34. Each spreadsheet further comprises a lead sheet. Once the application (e.g., Microsoft Excel) calculates reporting values 34, the application stores reporting values 34 in the lead sheet of workpaper 16.

In the present example, memory 52 comprises workstream profile 56 for the particular workstream 12. In workstream profile 56, manager server 30 records the number of workpapers 16 that are in each stage 32 of completion. In this example, the first stage 32 of completion is “Not Started”—this stage 32 includes workpapers 16 that have not yet been opened by the assigned preparers 38. The second stage 32 is “In Progress”—this stage 32 includes (1) workpapers 16 that have be opened but not submitted for review and (2) workpapers 16 that have been submitted for review but were rejected by reviewer 42. The third stage 32 is “Under Review”—this stage 32 includes workpapers 16 that have been submitted for review. The fourth stage 32 is “Approved”—this stage 32 includes workpapers 16 that have been signed off by the assigned reviewer 42.

In the present example, manager server 30 monitors the current status of each workpaper 16 in storage module 40. As a particular workpaper 16 is started, submitted for review, rejected, or approved, manager server 30 updates workstream profile 56 to reflect the updated number of workpapers 16 in each stage 32 of completion.

Each stage 32 of completion is associated with a respective weight 48. In the present example, weight 48 for a particular stage 32 corresponds to the relative amount of time needed by preparer 38 and/or reviewer 42 to reach the particular stage 32. In particular, weight 48 for the first stage 32 (i.e., “Not Started”) is 0.0 because none of the time budgeted for the assignment is needed to achieve this stage 32. Weight 48 for the second stage 32 (i.e., “In Progress”) is 0.3 because approximately 30% of the budgeted time of user 18 is needed to achieve this stage 32. Weight 48 for the third stage 32 (i.e., “Under Review”) is 0.7 because approximately 70% of the budgeted time of user 18 is needed to achieve this stage 32. Weight 48 for the fourth stage 32 (i.e., “Approved”) is 1.0 because approximately 100% of the budgeted time is needed to achieve this stage 32.

In the present example, manager server 30 stores in workstream profile 56 the percentage of the total workpapers 16 that are in each stage 32. Accordingly, manager server 30 records in workstream profile 56 that 10% of workpapers 16 are not started, 40% of workpapers 16 are in progress, 30% of workpapers 16 are under review, and 20% of workpapers 16 are approved. For each stage 32, manager server 30 determines the product of the weight 48 for the particular stage 32 and the percentage of the total workpapers 16 that are in the particular stage 32. This product may be referred to as component percentage 62. In this example, manager server 30 determines that component percentage 62 for the first stage 32 (i.e., “Not Started) is zero, component percentage 62 for the second stage 32 (i.e., “In Progress”) is 12%, component percentage 62 for the third stage 32 (i.e., “Under Review”) is 21%, and component percentage 62 for the fourth stage 32 (i.e., “Approved”) is 20%. In this example, manager server 30 is configured to calculate completion percentage 28 by adding together each component percentage 62. Accordingly, manager server 30 determines that completion percentage 28 for the particular workstream 12 is 53% (i.e., 12%+21%+20%). In this example, manager server 30 may store completion percentage 28 in workstream profile 56 and/or transmit completion percentage 28 to one or more clients 20.

In the foregoing example, workstream profile 56 comprised four stages 32 (i.e., “Not Started”, “In Progress”, “Under Review”, and “Approved”). It should be understood, however, that workstream profile 56 may comprise any suitable number and combination of stages 32 associated with workpapers 16.

In the foregoing example, weight 48 for a particular stage 32 corresponded to the relative amount of time needed by preparer 38 and/or reviewer 42 to reach the particular stage 32. It should be understood, however, that weight 48 for a particular stage 32 may be based at least in part on the cost required to complete the particular stage 32, the system resources required to complete the particular stage 32, and/or on any number and combination of suitable criteria.

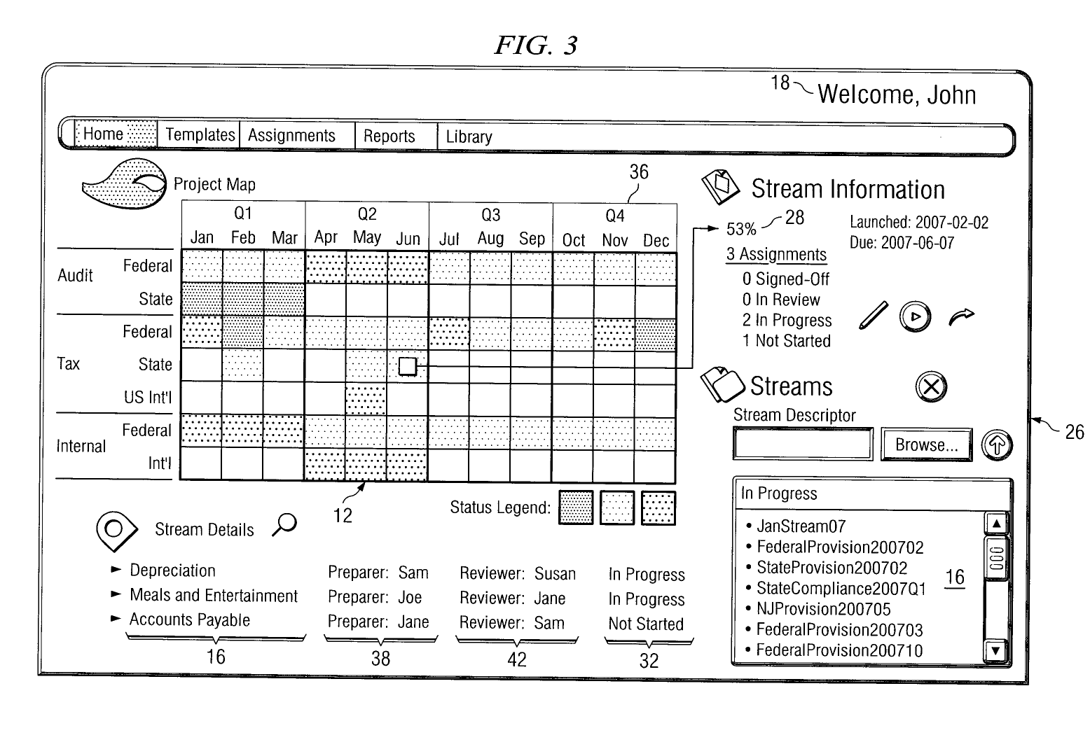

FIG. 3 illustrates an example GUI 26 for displaying project map 36 and completion percentage 28, according to certain embodiments. In the present example, a particular user 18, John, has used client 20 to log into workflow system 10. John has been assigned to work on a project that involves preparing financial reports and filings for a particular corporation. Upon detecting that John has logged in, manager server 30 causes client 20 associated with John to display the illustrated project map 36.

Project map 36 indicates the status of multiple workstreams 12 that are associated with the overall project of preparing tax filings for the particular corporation. In particular, the overall project comprises a first workstream 12 to prepare federal audit reports for the first quarter of 2006, a second workstream 12 to prepare federal audit reports for the second quarter of 2006, and so forth. The overall project further comprises workstreams 12 for preparing monthly federal, state, and international tax filings as well as quarterly internal reports.

In some embodiments, project map 36 may display a box for each workstream 12 associated with the particular project. The color of the displayed box may indicate the general status of the workstream 12. For example, if a particular workstream 12 is completed, project map 36 may display the box for the particular workstream 12 as green. If the particular workstream 12 has not been started, project map 36 may display the box for the particular workstream 12 as blue. By providing a color coded box for each workstream 12, project map 36 may efficiently provide user 18 with a broad understanding of the status of the particular project.

According to certain embodiments, client 20 may allow user 18 to select a particular workstream 12 in order to obtain more detailed status information. In the present example, the particular user 18, John, selects the box that corresponds to workstream 12 for June 2006 state tax filings. Upon detecting John's selection, manager server 30 identifies in memory 52 the particular workstream profile 56 for June 2006 state tax filings. From the particular workstream profile 56, manager server 30 determines and causes client 20 to display the current completion percentage 28. In the present example, the completion percentage 28 of 53% is displayed in conjunction with the selected workstream 12 (i.e., June 2006 state tax filings.) By displaying completion percentage 28 for any selected workstream 12, project map 36 may provide user 18 with a useful and detailed understanding of the current status of a particular workstream 12.

In some embodiments, in conjunction with displaying completion percentage 28 for a particular workstream 12, GUI 26 may display other relevant information regarding the selected workstream 12. For example, GUI 26 may display the date that the particular workstream 12 was launched, the date that the particular workstream 12 is due, the identity of the company or legal entity associated with the particular workstream 12, and/or other suitable information regarding the selected workstream 12.

According to certain embodiments, upon detecting the selection of a particular workstream 12, manager server 30 may cause GUI 26 to display stream details such as, for example, the particular workpapers 16 associated with the selected stream. In the present example, under the heading “Stream Details”, GUI 26 displays information regarding each workpaper 16 associated with the June 2006 state tax filing workstream 12. For example, GUI 26 displays that a particular workpaper 16 for depreciation, which is in progress, was assigned to Sam as the preparer 38 and Susan as the reviewer 42.

In some embodiments, in conjunction with displaying project map 36, GUI 26 may display a task list for the particular user 18. In the present example, under the heading “Task List”, GUI 26 displays a list of all workpapers 16 that have been assigned to John and that have not been approved. By selecting one of the tasks displayed in the task list, John may cause manager server 30 and/or client 20 to launch the selected workpaper 16. John may then use client 20 to work on the selected workpaper 16. By displaying a project map 36 and providing a task list that facilitates the launching of workpapers 16, GUI 26 provides an efficient dashboard for monitoring the status of workstreams 12, reviewing due dates, and navigating to workpapers 16.

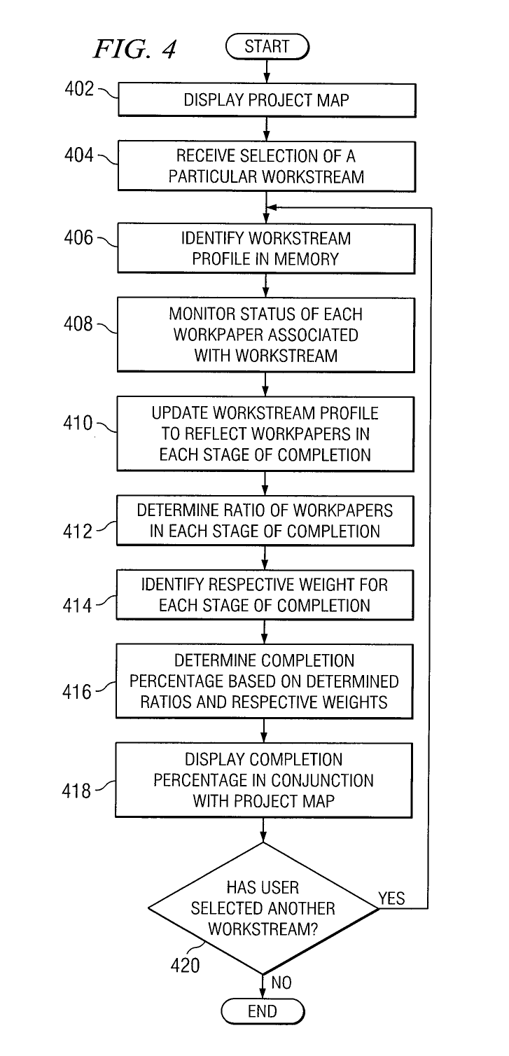

FIG. 4 illustrates a flowchart for updating completion percentage 28 associated with a particular workstream 12, according to certain embodiments. The method begins at step 402 when client 20 displays project map 36. In some embodiments, project map 36 indicates the status of multiple workstreams 12 that are associated with a particular project. Each workstream 12 displayed in project map 36 may be associated with a plurality of workpapers 16. A plurality of preparers 38 and reviewers 42 may be assigned to complete the plurality of workpapers 16. At step 404, manager server 30 receives a selection of a particular workstream 12 displayed in project map 36. In some embodiments, the selection of the particular workstream 12 may be based on a selection and/or input from user 18 associated with client 20.

At step 406, manager server 30 identifies in memory 52 the particular workstream profile 56 associated with the selected workstream 12. In some embodiments, manager server 30 records in workstream profile 56 the respective number of workpapers 16 that are in each stage 32 of completion. Workstream profile 56 may further comprise a respective weight 48 for each stage 32 of completion. At step 408, manager server 30 monitors the status of each workpaper 16 associated with the particular workstream 12. In some embodiments, manager server 30 is operable to detect when a particular workpaper 16 transitions from one stage 32 of completion to another stage 32 of completion. In particular, manager server 30 may detect when preparer 38 begins working on workpaper 16, when preparer 38 submits workpaper 16 for review, when reviewer 42 rejects or approves workpaper 16, and/or when workpaper 16 satisfies any suitable number and combination of criteria. At step 410, manager server 30 updates workstream profile 56 to reflect the current number of workpapers 16 that are in each stage 32 of completion.

At step 412, for each stage 32 of completion in workstream profile 56, manager server 30 determines the respective ratio of workpapers 16 that are in the respective stage 32 of completion. In some embodiments, stages 32 of completion may include “Not Started”, “In Progress”, “Under Review”, and “Approved”. At step 414, manager server 30 identifies in workstream profile 56 the respective weight 48 for each stage 32 of completion. In some embodiments, the particular weight 48 for each stage 32 may be based at least in part on the estimated time, estimated cost, and/or estimated system resources that are needed to complete a particular workpaper 16 that is currently in the particular stage 32.

At step 416, manager server 30 determines completion percentage 28 based at least in part on the determined ratios and the respective weights 48. Manager server 30 may store completion percentage 28 in workstream profile 56. At step 418, manager server 30 causes client 20 to display completion percentage 28 in conjunction with project map 36. At step 420, manager server 30 determines whether user 18 has selected another workstream 12 displayed in project map 36. If user 18 has selected another workstream 12 at step 420, the method returns to step 406 and repeats the process for the other selected workstream 12. If manager server 30 determines at step 420 that user 18 has not selected another workstream 12, the method then ends.

FIG. 5 illustrates an example GUI 26 for monitoring file permissions 22 associated with workpapers 16. In some embodiments, manager server 30 is operable to dynamically manage file permissions 22 based at least in part on workstream events. As explained above, each workstream 12 is associated with a plurality of workpapers 16. In some embodiments, a plurality of preparers 38 and reviewers 42 are assigned to complete the plurality of workpapers 16. In particular, a particular workpaper 16 may be assigned to a respective preparer 38 and reviewer 42. In some embodiments, manager server 30 initially designates preparer 38 as having read-write access to the particular workpaper 16. Manager server 30 may designate reviewer 42 as having read-only access to the particular workpaper 16. Read-write access and read-only access are examples of file permissions 22. In some embodiments, manager server 30 may store file permissions 22 for a particular workpaper 16 in storage module 40 in association with the particular workpaper 16.

As explained above, manager server 30 is operable to monitor workpapers 16 for particular workstream events. For example, manager server 30 may monitor workpaper 16 to determine when preparer 38 begins work on workpaper 16, to determine when preparer 38 submits workpaper 16 for review, to determine when reviewer 42 approves or rejects workpaper 16, and/or to determine the occurrence of any suitable workstream event. In some embodiments, in response to detecting a particular workstream event associated with a particular workpaper 16, manager server 30 may modify file permissions 22 associated with the particular workpaper 16. For example, manager server 30 may be configured to monitor workpapers 16 to determine when preparer 38 submits a particular workpaper 16 for review. Upon detecting that preparer 38 submitted a particular workpaper 16 for review, manager server 30 may change file permissions 22 of preparer 38 for the particular workpaper 16 from read-write to read-only. If reviewer 42 rejects the particular workpaper 16, manager server 30 may change file permissions 22 of preparer 38 for the particular workpaper 16 back to read-write. If reviewer 42 approves the particular, workpaper 16, manager server 30 may leave file permissions 22 of preparer 38 for the particular workpaper 16 as read-only.

In some embodiments, by changing the file permissions 22 of preparer 38 to read-only while the particular workpaper 16 is under review, manager server 30 may increase the integrity of the audit trail associated with the particular workpaper 16. According to certain embodiments, by monitoring the status of workpapers 16, manager system may automatically change file permissions 22 in response to predetermined workstream events. Accordingly, manager server 30 may change file permissions 22 without sending a request to a systems administrator 44 and/or without waiting for the systems administrator 44 to manually change file permissions 22, which may sometimes be a time-consuming process. Thus, by dynamically managing file permissions 22 in response to workstream events, workflow system 10 may change file permissions 22 more efficiently than traditional systems.

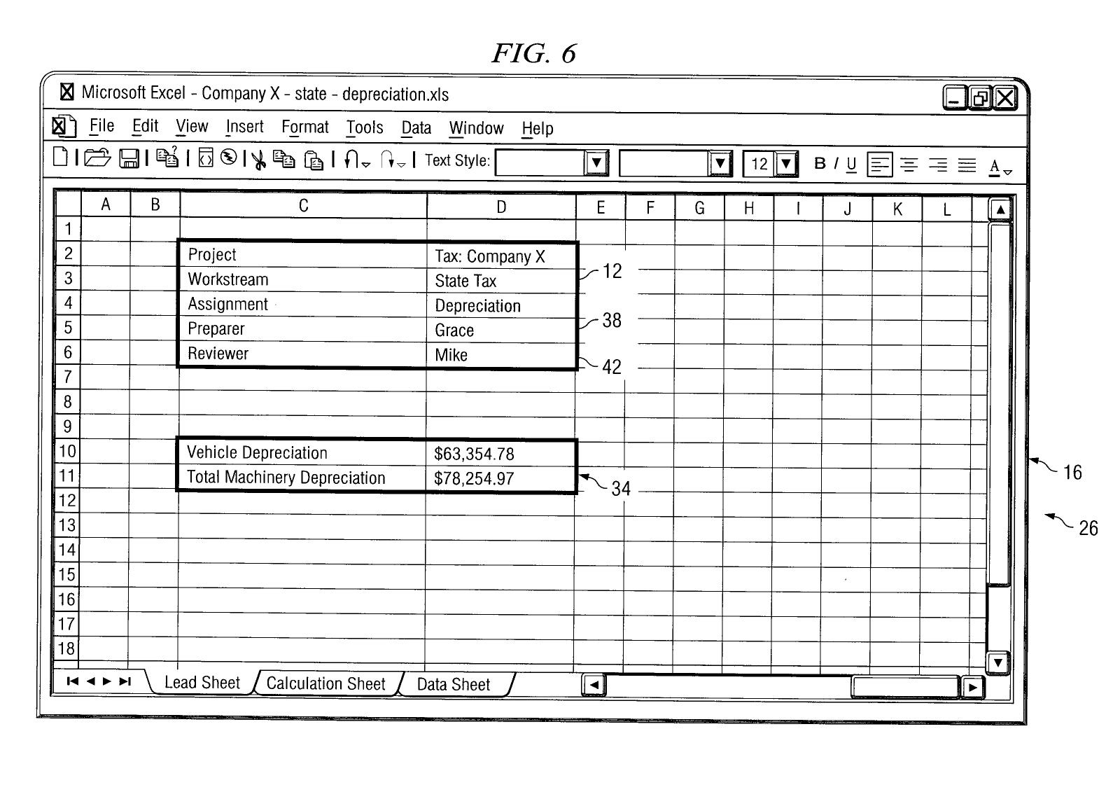

FIG. 6 illustrates an example lead sheet of workpaper 16 that comprises reporting values 34, according to certain embodiments. In some embodiments, manager server 30 is operable to automatically load reporting values 34 from workpapers 16 into database 46. As explained above, a particular workstream 12 may comprise a plurality of assignments. Each assignment may be associated with a respective workpaper 16 that is based on one or more templates 24. According to certain embodiments, each workpaper 16 may comprise rules and formulas for filtering and processing source data 14 to calculate reporting values 34. In some embodiments, the calculated reporting values 34 may be displayed in a lead sheet of the particular workpaper 16.

In some embodiments, once user 18 checks in a particular workpaper 16, manager server 30 may automatically extract one or more reporting values 34 from the lead sheet of the particular workpaper 16 and store the one or more reporting values 34 in database 46. Thus, database 46 may represent a centralized repository for reporting values 34. Because reporting values 34 were extracted from workpapers 16 when workpapers 16 were checked in by users 18, reporting values 34 are centrally located in database 46. Thus, upon receiving a command to generate a regulatory filing or report, manager server 30 may efficiently retrieve reporting values 34 from database 46 rather than having to individually read reporting values 34 from each workpaper 16 in storage module 40.

In some embodiments, a project may comprise a plurality of workstreams 12. When a new project arises, administrator 44 may use client 20 to identify the particular workstreams 12 in the project that must be completed in order to complete the project. Each workstream 12 may comprise a plurality of assignments. In some embodiments, each assignment may be associated with a respective assignment type that corresponds to one of a plurality of templates 24. At any given point in time, manager server 30 may identify which workstreams 12 have not been started. By submitting a single command to manager server 30, administrator 44 may cause manager server 30 to generate a respective workpaper 16 for each assignment in the identified workstreams 12. Each generated workpaper 16 may be based on a respective template 24. Thus, in response to a single command, manager server 30 may generate any suitable number (e.g., tens, hundreds, etc.) of workpapers 16. In some embodiments, because each workpaper 16 is based on an approved template 24, each workpaper 16 is configured to maintain the integrity of the information that is loaded into the particular workpaper 16.

Although the present invention has been described in detail, it should be understood that various changes, substitutions, and alterations can be made hereto without departing from the scope of the invention as defined by the appended claims.

What is claimed is:

1. A system, comprising:
a memory operable to store one or more workpapers; and
a processor communicatively coupled to the memory and operable to:
determine a completion percentage associated with a particular workstream, wherein:
the particular workstream is associated with a plurality of workpapers;
a first portion of the plurality of workpapers are in a first stage of completion;
a second portion of the plurality of workpapers are in a second stage of completion;
determining the completion percentage comprises:
determining a first percentage based at least in part on the first portion and a first weight;
determining a second percentage based at least in part on the second portion and a second weight; and
adding the first percentage and the second percentage; and
store the determined completion percentage in a memory.

2. The system of claim 1, wherein:
the first stage represents drafting one or more workpapers; and
the second stage represents reviewing one or more workpapers.

3. The system of claim 2, wherein:
a third portion of the plurality of workpapers are in a third stage of completion; and
determining the completion percentage further comprises:
determining a third percentage based at least in part on the third portion and a third weight; and
adding the third percentage to a sum of the first percentage and the second percentage.

4. The system of claim 3, wherein:
the third stage corresponds to one or more workpapers that have been approved after review; and
the third weight is more than the first weight and more than the second weight.

5. The system of claim 1, wherein determining the first percentage comprises:
determining a ratio of the first portion to the plurality of workpapers; and
multiplying the ratio by the first weight.

6. The system of claim 1, wherein the first weight is based at least in part on at least one of the following:
an estimated amount of time to complete a particular workpaper in the first stage of completion; and
an estimated cost to complete a particular workpaper in the first stage of completion.

7. The system of claim 1, wherein:
the first stage represents preparing one or more workpapers;
the second stage represents reviewing one or more workpapers; and
the processor is further operable to:
in response to at least one workpaper in the first stage being submitted for review, update the first percentage and the second percentage; and
determine an updated completion percentage based at least in part on the updated first percentage and the updated second percentage.

8. The system of claim 1, wherein:
each of the plurality of workpapers are assigned to a respective one of a plurality of users; and
the processor is further operable to cause a client associated with a particular user to display:
the determined completion percentage associated with the particular workstream; and
a list of workpapers that are assigned to the particular user.

9. The system of claim 1, wherein the processor is further operable to:
display a plurality of workstreams; and
in response to a user selection of the particular workstream, display the determined completion percentage.

10. A method, comprising:
determining a completion percentage associated with a particular workstream, wherein:
the particular workstream is associated with a plurality of workpapers;
a first portion of the plurality of workpapers are in a first stage of completion;
a second portion of the plurality of workpapers are in a second stage of completion;
determining the completion percentage comprises:
determining a first percentage based at least in part on the first portion and a first weight;
determining a second percentage based at least in part on the second portion and a second weight; and
adding the first percentage and the second percentage; and
storing the determined completion percentage in a memory.

11. The method of claim 10, wherein:
the first stage represents drafting one or more workpapers; and
the second stage represents reviewing one or more workpapers.

12. The method of claim 11, wherein:
a third portion of the plurality of workpapers are in a third stage of completion; and
determining the completion percentage further comprises:
determining a third percentage based at least in part on the third portion and a third weight; and
adding the third percentage to a sum of the first percentage and the second percentage.

13. The method of claim 12, wherein:
the third stage corresponds to one or more workpapers that have been approved after review; and
the third weight is more than the first weight and more than the second weight.

14. The method of claim 10, wherein determining the first percentage comprises:
determining a ratio of the first portion to the plurality of workpapers; and
multiplying the ratio by the first weight.

15. The method of claim 10, wherein the first weight is based at least in part on at least one of the following:
an estimated amount of time to complete a particular workpaper in the first stage of completion; and
an estimated cost to complete a particular workpaper in the first stage of completion.

16. The method of claim 10, wherein:
the first stage represents preparing one or more workpapers; and
the second stage represents reviewing one or more workpapers; and further comprising:
in response to at least one workpaper in the first stage being submitted for review, updating the first percentage and the second percentage; and
determining an updated completion percentage based at least in part on the updated first percentage and the updated second percentage.

17. The method of claim 10, wherein each of the plurality of workpapers are assigned to a respective one of a plurality of users, and further comprising:
causing a client associated with a particular user to display:
the determined completion percentage associated with the particular workstream; and
a list of workpapers that are assigned to the particular user.

18. The method of claim 10, further comprising:
displaying a plurality of workstreams; and
in response to a user selection of the particular workstream, displaying the determined completion percentage.

19. Logic embedded in a computer readable medium and operable when executed by a processor to:
determine a completion percentage associated with a particular workstream, wherein:
the particular workstream is associated with a plurality of workpapers;
a first portion of the plurality of workpapers are in a first stage of completion;
a second portion of the plurality of workpapers are in a second stage of completion;
determining the completion percentage comprises:
determining a first percentage based at least in part on the first portion and a first weight;
determining a second percentage based at least in part on the second portion and a second weight; and
adding the first percentage and the second percentage; and
store the determined completion percentage in a memory.

20. The logic of claim 19, wherein the first weight is based at least in part on at least one of the following:
an estimated amount of time to complete a particular workpaper in the first stage of completion; and
an estimated cost to complete a particular workpaper in the first stage of completion.
